(19) United States
(12) Patent Application Publication
(10) Pub. No.: US 2018/0243591 A1
(43) Pub. Date: Aug. 30, 2018

(54) METHOD AND APPARATUS FOR AN EMERGENCY AIR BREATHING SYSTEM

(71) Applicant: DMD Fire Equipment, LLC, Gilbert, AZ (US)

(72) Inventor: Daniel C. DeWitt, Gilbert, AZ (US)

(21) Appl. No.: 15/968,647

(22) Filed: May 1, 2018

Related U.S. Application Data
(63) Continuation-in-part of application No. 15/066,977, filed on Mar. 10, 2016, now abandoned.
(60) Provisional application No. 62/179,173, filed on Apr. 29, 2015.

(51) Int. Cl. A62B 7/10; A62B 9/02; A62B 9/04

(52) U.S. Cl. CPC A62B 7/10; A62B 9/04; A62B 9/02

(57) ABSTRACT

An emergency air breathing system according to various aspects of the present technology is configured to utilize a standard operational firehose to refill an air tank carried by a firefighter or otherwise provide breathable air to the firefighter through their SCBA while fighting a fire. Various embodiments of the emergency air breathing system comprise a coupling device that can be selectively connected on a first end to a fire hose nozzle and a fire hose at a second end. A conduit section extends between the first and second ends and is configured to redirect a supply of breathable air out from a port in the conduit section and through a valve housing that can be selectively connected to the firefighter's air tank or a transfill hose of the SCBA.

### CROSS-REFERENCES TO RELATED APPLICATIONS

This application is a continuation-in-part of U.S. patent application Ser. No. 15/066,977, filed Mar. 10, 2016, which claims the benefit of U.S. Provisional Patent Application No. 62/179,173, filed Apr. 29, 2015, and incorporates the disclosure by reference. To the extent that the present disclosure conflicts with any referenced application, however, the present disclosure is to be given priority.

### BACKGROUND OF INVENTION

Firefighters often carry a self-contained breathing apparatus (SCBA) during the course of fighting a fire or entering a situation where an external air supply is required. When firefighters become trapped or injured in a hazardous environment, their SCBA may become deprived of breathable air causing the firefighter to die from asphyxiation. There is a tendency to implement high risk rescue procedures for a trapped or injured firefighter. However, it is widely known that rescue operations are time consuming, and in many cases, the firefighter may run out of air before any rescue efforts can be mounted and reach the firefighter. Existing systems for providing firefighters with additional breathable air have included the use of supply breathable air through a firehose and then capturing that air with an airbag from the end of the nozzle or positioning an air hose within the firehose itself to form a multi-channel hose. These types of systems have been difficult to implement safely or incorporate effectively into existing firefighting systems without high retrofit costs.

### SUMMARY OF THE INVENTION

An emergency air breathing system according to various aspects of the present technology is configured to utilize a standard operational firehose to refill an air tank carried by a firefighter or otherwise provide breathable air to the firefighter through their SCBA while fighting a fire. Various embodiments of the emergency air breathing system comprise a coupling device that can be selectively connected on a first end to a fire hose nozzle and a fire hose at a second end. A conduit section extends between the first and second ends and is configured to redirect a supply of breathable air out from a port in the conduit section and through a valve housing that can be selectively connected to the firefighter's air tank or a transfill hose of the SCBA.

### BRIEF DESCRIPTION OF THE DRAWINGS

A more complete understanding of the present technology may be derived by referring to the detailed description when considered in connection with the following illustrative figures. In the following figures, like reference numbers refer to similar elements and steps throughout the figures.

FIG. 1A representatively illustrates a side view of an emergency breathing device in accordance with a first embodiment of the technology;

FIG. 1B representatively illustrates a perspective view of the emergency breathing device in accordance with the first embodiment of the technology;

FIG. 2 representatively illustrates a side view of the emergency breathing device coupled to a fire nozzle and a fire hose in accordance with the first embodiment of the technology;

FIG. 3 representatively illustrates an exploded view of the emergency breathing device and the fire nozzle in accordance with the first embodiment of the technology;

FIG. 4 representatively illustrates a cross-sectional view of the emergency air breathing device in accordance with the first embodiment of the technology;

FIG. 5A representatively illustrates a side view of an emergency breathing device in accordance with a second embodiment of the technology;

FIG. 5B representatively illustrates a perspective view of the emergency breathing device in accordance with a second embodiment of the technology;

FIG. 6 representatively illustrates an exploded view of the emergency breathing device in accordance with the second embodiment of the technology;

FIG. 7 representatively illustrates an emergency breathing device coupled to a fire hose nozzle in accordance with the second embodiment of the technology;

FIG. 8 representatively illustrates a cross-sectional view of the emergency air breathing device in accordance with the second embodiment of the technology;

FIG. 9A representatively illustrates an emergency breathing device integrated into a fire hose nozzle in accordance with a third embodiment of the technology;

FIG. 9B representatively illustrates an emergency breathing device integrated into a fire hose nozzle in accordance with a fourth embodiment of the technology;

FIG. 10 representatively illustrates the emergency breathing device fluidly linked to a control panel at a fire truck and connected to a transfill hose in accordance with an exemplary embodiment of the technology;

FIG. 11 representatively illustrates a block diagram of the control panel in accordance with an exemplary embodiment of the technology;

FIG. 12 representatively illustrates a flowchart depicting the emergency air breathing system being utilized in accordance with an exemplary embodiment of the technology; and

FIG. 13 representatively illustrates a block diagram depicting various sources of air that can be utilized by the emergency air breathing system in accordance with an exemplary embodiment of the technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various process steps, apparatus, systems, methods, etc. In addition, the present technology may be practiced in conjunction with any number of systems and methods for supplying breathable air to an air tank or a self-contained breathing apparatus (SCBA), and the system described is merely one exemplary application for the technology. Further, the present technology may employ any number of conventional techniques for installing, removing, pumping, diverting, and dispensing materials pumped from a source end to a use end.

Methods and apparatus for an emergency air breathing system according to various aspects of the present technology may operate in conjunction with any suitable substance dispensing nozzle and/or any suitable substance dispensing source. Various representative implementations of the present technology may be applied to any fire suppressing and/or breathable air systems.

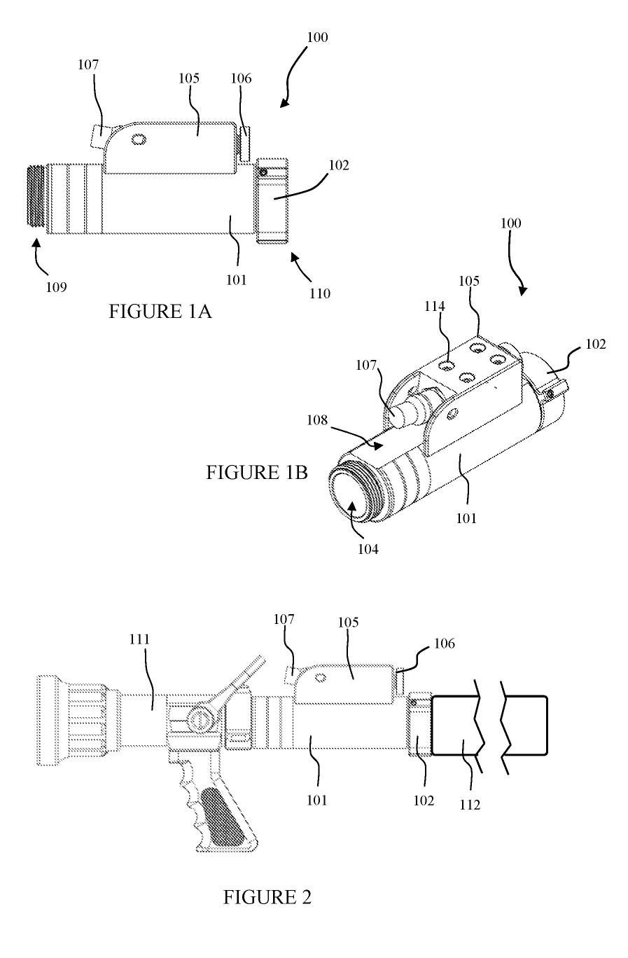

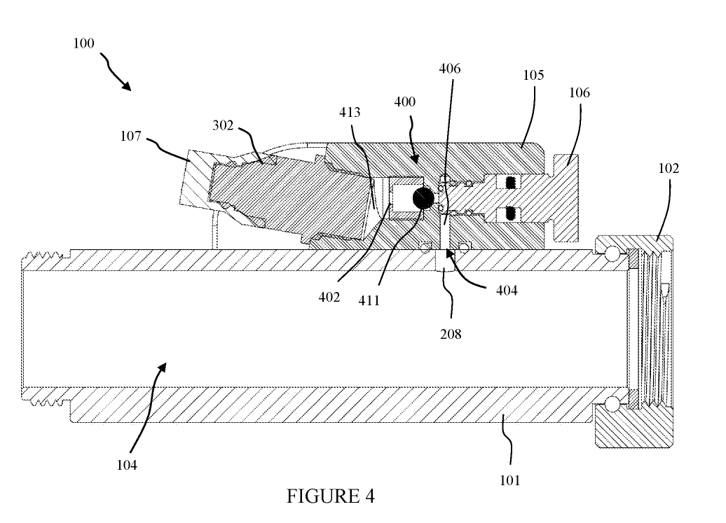

Referring now to FIGS. 1-4 and 10, in a first embodiment of the present technology, an emergency air breathing system 100 may be positioned between a fire hose nozzle 111 and a fire hose 112 and be configured to function during normal firefighting operations to allow a fire extinguishant received from a source end, such as a fire engine 1000, to flow from the fire hose 112 to the fire hose nozzle 111.

In one embodiment, the emergency air breathing system 100 may comprise a coupling body 101 configured facilitate the flow of the fire extinguishant received from the fire hose 112, through the coupling body 101, and to the fire hose nozzle 111. The fire extinguishant may comprise any material commonly used to combat fires, including but not limited to gaseous or liquid fluids, plasmas, solids, gels, foams, and/or the like. For example, the fire extinguishant may comprise any suitable fire suppressant material such as foam, gel, water, and/or the like.

The coupling body 101 may comprise a substantially cylindrical body with a first end 109 configured to be detachably coupled to at least one of the fire nozzle 111 and a fire hose 112. For example, in one embedment, the first end 109 of the coupling body 101 may be configured to be detachably coupled directly to the fire nozzle 111 and the second end 110 may be coupled to the fire hose 112. In an alternative embodiment, the first end 109 may be detachably coupled to a first section of the fire hose 112 and the second end 110 may be detachably coupled to a second section of the fire hose 112 such that the coupling body 101 may be disposed between two sections of the fire hose 112 that are proximate to the firefighter during use.

A conduit flow section 104 extends between the first and second ends 109, 110 of the body and is in direct fluid communication with the fire hose 112. The conduit flow section 104 comprises a diameter substantially equal to that of the fire hose 112 to allow the fire extinguishant to flow with minimal restriction or obstruction between the first and second ends 109, 110. For example, although the conduit flow section 104 may comprise any suitable diameter corresponding to a particular type of fire hose 112, common sizes of fire hoses 112 used on most firetrucks typically range between one and one-half inches and three inches in diameter. However, the diameter of the fire hose 112 may comprise diameters in excess of three inches in situations where a longer run is needed, such as when the firetruck cannot get within 500 hundred feet of the fire. Because the diameter of a given conduit flow section 104 is selected according to the type of fire hose 112 that the coupling body 101 is being connected to, the coupling body 101 may be provided in multiple sizes. Accordingly, in use, the diameter of the conduit flow section 104 should be substantially identical to the diameter of the fire hose 112.

The coupling body 101 may be formed from any substance suitably configured to facilitate the flow of a fire extinguishant such as metals, plastics, fabrics, composites, and/or the like. For example, the coupling body 101 may comprise a metal or metallic alloy capable of withstanding elevated temperatures associated with a fire. Several structural characteristics of the coupling body 101 may depend on the application of the emergency air breathing system 100. For example, the coupling body 101 may comprise a rigid body comprising a material suited for holding a liquid at pressures of up to about 900 pounds per square inch (psi). In other situations, the coupling body 101 may comprise a lightweight and flexible material.

In one embodiment, the first end 109 and/or the second end 110 of the coupling body 101 may be configured for connection to standard firefighting components. For example, the first end 109 may comprise a threaded male end configured to allow the coupling body 101 to be selectively coupled to and from the fire hose nozzle 111, fire hose 112, and/or any applicable object and/or structure. The threaded end may comprise a Higbee cut/thread to allow coupling body 101 to be attached or otherwise coupled to existing firefighting systems and devices with reduced likelihood of cross threading.

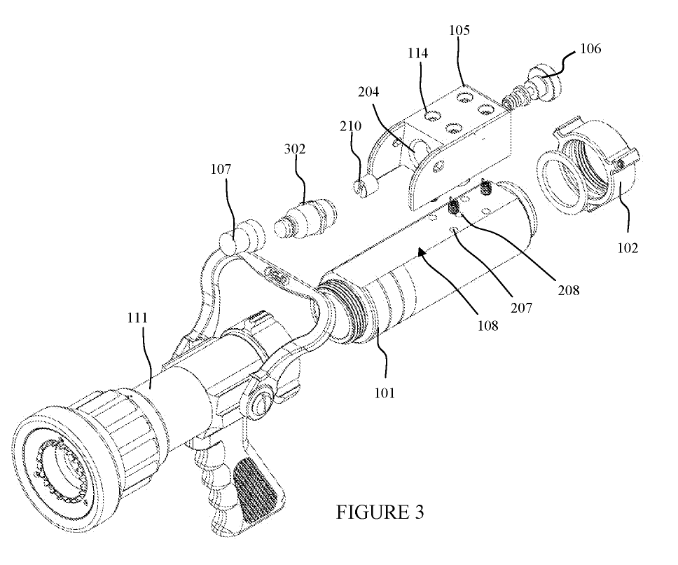

Alternatively or additionally, the first end 109 and/or second end 110 of the coupling body 101 may comprise female coupling 102 configured to be attached or otherwise coupled to a matching male coupling member such as a threaded male end. The female coupling may further comprise a gasket 205 that is suitably adapted to provide a seal between the coupling body 101 and the mating component. For example, the gasket 205 may be configured to slide over the threaded ends one of the first or second ends 109, 110 of the coupling body 101 configured to receive the fire hose 112. The gasket 205 may be configured to create a seal between the coupling body 101 and the female coupling 102 as shown in FIG. 3 to prevent the extinguishant flowing through the fire hose 112 from leaking before it enters the conduit flow section 104 of the coupling body 101.

Referring now to FIGS. 3, 4, 6, and 9, during use, the emergency air breathing system 100 may be configured to have a fire extinguishant such as a water/foam mixture initially flow through the conduit flow section 104 before flowing out of the fire hose nozzle 111. In the event of an emergency condition/event, the fire extinguishant may be flushed from the fire hose 112, the conduit flow section 104, and the fire hose nozzle 111 may be pressurized with breathable air. Once complete, the newly supplied breathable air may flow into the conduit flow section 104 where at least a portion of the pressurized breathable air may be selectively diverted through an exit port 208 and into a valve housing 105 where the breathable air may be delivered to the SCBA worn by a firefighter.

The exit port 208 is disposed along a surface of the conduit flow section 104 and creates a fluid path from the conduit flow section 104 to an outer surface 108 of the coupling body 101. The exit port 208 may comprise any suitable flow path from the conduit flow section 104 to the outer surface 108 to allow the flow of breathable air at a sufficient rate to allow at least one firefighter to breathe safely. For example, the exit port 208 may comprises a through hole or channel disposed on the coupling body 101 that extends between the outer surface 108 and the conduit flow section 104. In one embodiment, the exit port 208 may be sized to provide a predetermined mass flow rate of breathable air from the conduit flow section 104 to the valve housing 105 that allows for the direct breathing by at least one firefighter and/or the refilling of an air tank connected to the SCBA. For example, a mass flow rate of breathable air may be supplied at a pressure exceeding 300 psi that is intended to be provided directly to an air tank connected to the SCBA which the firefighter can breathe from. Alternatively, the breathable air may be provided at a lower pressure to the SCBA such that the firefighter can breathe the supplied air directly.

The exit port 208 may comprise any suitable diameter suitable for allowing breathable air to flow at a desired rate. The diameter of the exit port 208 may be selected according to any suitable criteria such as a desired operating pressure in the conduit flow section 104, a maximum run of fire hose length, a diameter of the fire hose 112, and/or a desired mass flow rate out of the valve housing 105. The size of the exit port 208 may also be selected to help maintain a pressure inside of the conduit flow section 104 and the fire hose 112. For example, if the diameter of the exit port 208 is less than ten percent that of the conduit flow section 104, a sufficient mass flow rate of breathable air may be passed through to the SCBA without causing the pressure in the entire fire hose 112 to drop significantly.

For example, in one embodiment, the fire hose 112 and conduit flow section 104 may be pressurized with breathable air between 70 and 800 psi and the exit port 208 may comprise a diameter of between one-sixtyfourths of an inch and one-eighth of an inch. In an alternative embodiment, the fire hose 112 and conduit flow section 104 may be pressurized with breathable air between approximately 325 psi and 450 psi and the exit port 208 may comprise a diameter of between one-thirtysecondths of an inch and three-thirtysecondths of an inch. In yet another embodiment, the fire hose 112 and conduit flow section 104 may be pressurized with breathable air between approximately 70 psi and 170 psi and the exit port 208 may comprise a diameter of between one-thirtysecondths of an inch and three-thirtysecondths of an inch.

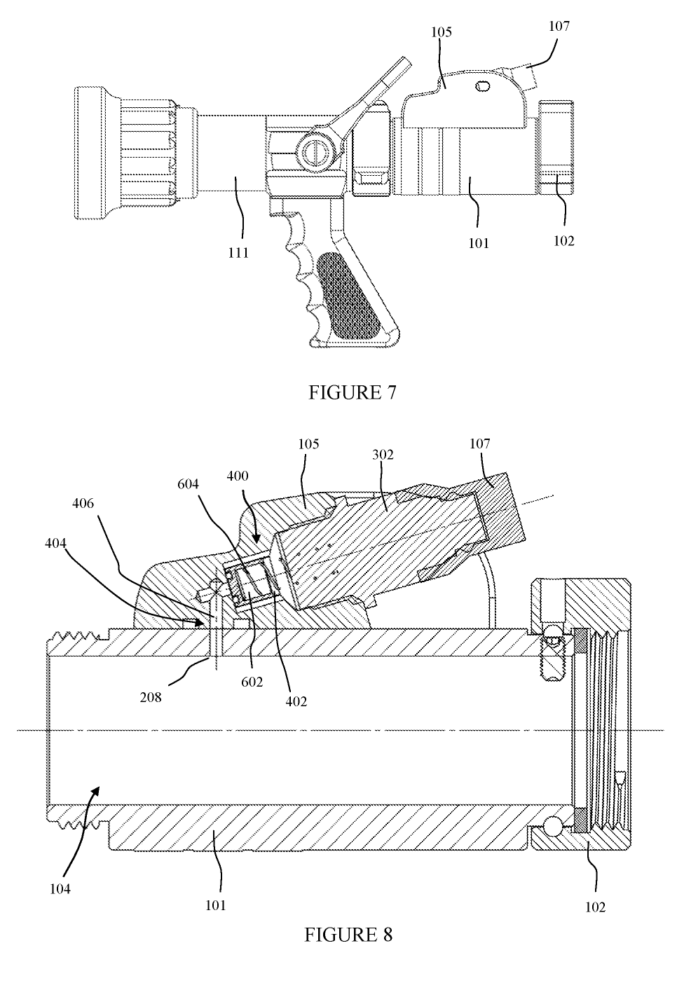

Referring now to FIGS. 1-9, the valve housing 105 may be disposed along or coupled to the outer surface 108 of the coupling body 101. For example, the outer surface 108 may comprise a substantially flat surface suitably configured to receive the valve housing 105. The outer surface 108 of the coupling body 101 may comprise a plurality of mounting holes 207. The plurality of mounting holes 207 may correspond to a series of corresponding mounting holes 114 disposed in the valve housing 105.

The valve housing 105 may comprise any suitable system or device configured to house a valve configured to control the flow of air received from the exit port 208 to the SCBA. The valve housing 105 may comprise an interior cavity 204 configured to receive at least a portion of an air coupling 302 and house a valve body 400, and an exhaust port 402. The valve body 210 may operate in conjunction with an intake port 404 that pneumatically links the valve body 400 to the conduit flow section 104 via a channel 406. The exhaust port 402 is disposed downstream of the intake port 404 on the opposite site form the valve body 400.

Referring now to FIGS. 1-4, in one embodiment, the valve body 400 may comprise a ball valve 411, a spring 413, and an actuating device 106. The intake port 404 may be disposed along a lower portion of the valve housing 105 and aligned with the exit port 208 of the coupling body 101 to form the channel 406 to the valve body 400.

The actuating device 106 may operate the valve body 400 to initiate or stop the flow of breathable air through the valve housing 105. The actuating device 106 may comprise any suitable system or device configured to move the valve body 400 between an open (flowing) state and an off (non-flowing) state. For example, when the valve body 400 is positioned in the open state, a flow of the pressurized breathable air from the conduit flow section 104 of the coupling body 101 is diverted out through the exit port 208 and into the channel 406. The pressurized breathable air acts on the ball valve 411 and overcomes a biasing pressure acting on the ball valve 411 by the spring 413. The ball valve 411 is unseated from a position sealing a pathway between the intake port 404 and the exhaust port 402 and the pressurized breathable air is able to flow to the air coupling 302 and out to the SCBA.

If the valve body 400 is positioned in the closed state, the flow of pressurized breathable air through the valve body is stopped and the biasing force from the spring 413 repositions the ball valve 411 sealing off the intake port 404 from the exhaust port 402 and stopping the flow of pressurized breathable air to the SCBA. In the closed position, the emergency air breathing system 100 prevents the flow of any material, including the fire extinguishant, through the valve body 400.

The actuating device 106 may comprise a shut-off valve configured to selectively actuate the ball valve 411 to allow the flow of the breathable air from the channel 406 into the valve body 400. In one embodiment, the shut-off valve may be pulled outwardly and/or otherwise operated (i.e., turned, rotated, flipped, and/or the like) from the valve housing 105 causing the emergency air breathing system 100 to switch into the open state.

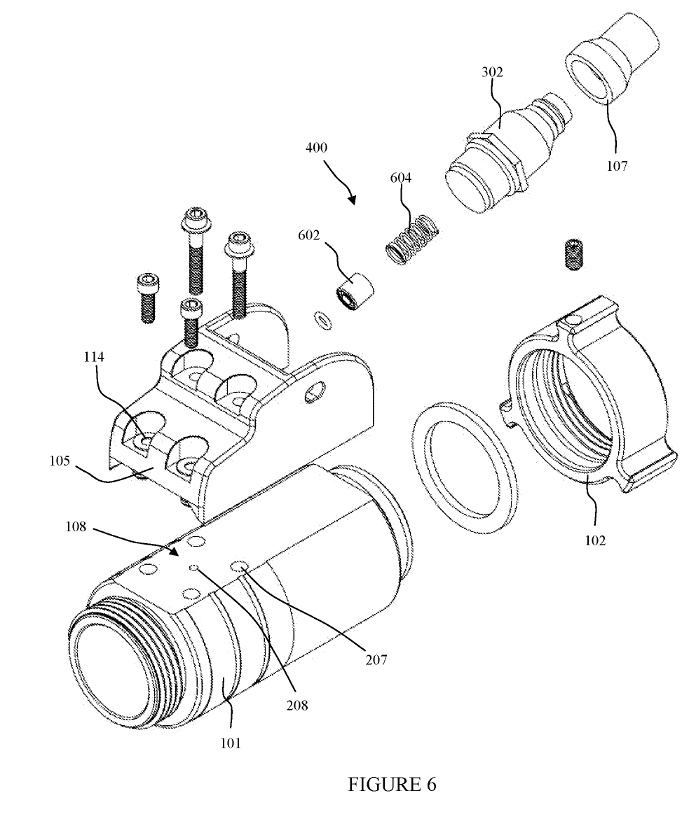

In an alternative embodiment, and referring now to FIGS. 6 and 8, the valve housing 105 may comprise a valve body 400 that is automatically actuated and does not require a manually operated actuator. For example, the valve housing 105 may comprise an intake port 404 and a channel 406 that are aligned with the exit port 208 on the coupling body 101 as described above. The valve housing 105 may further comprise an exhaust port 402 disposed downstream of the channel 406. A check valve 602 may be positioned between the intake port 404 and the exhaust port 402 and configured to allow the flow of the breathable air to flow on demand.

In this embodiment, the check valve 602 is biased in a closed positioned by a spring 604 to seal off the intake port 404 from the exhaust port 402 and prevent the flow of air or fire extinguishant through the valve housing 105. The check valve 602 may be responsive to changes in pressure at the exhaust port 402 and open and close according to a predetermined set of criteria.

For example, if an emergency condition/event occurs the fire hose 112 and the conduit flow section 104 may be flushed as pressurized with breathable air as described above. After the fire hose 112 and the conduit flow section 104 have been pressurized to a desired level, the firefighter may connect a transfill hose from their SCBA to the air coupling 302. Upon connecting the SCBA to the air coupling 302, a pressure drop at the exhaust port 402 will occur due to the lower pressure at the SCBA as compared to a pressure at the intake port 404. The check valve 602 is responsive to this pressure differential and automatically moves from the closed position to the open position. For example, the higher pressure at the intake port 402 overcomes the biasing force of the spring 604 allowing the pressurized breathable air to flow through the valve body 400 out through the air coupling 302.

If the breathable air passing through the valve housing 105 is flowing to an air tank and the firefighter isn't breathing the breathable air at a rate greater than it is being supplied, the air tank may begin to fill. As the air tank fills the excess breathable air gains pressure. When the air pressure in the air tank begins to approach the same pressure as the pressure at the intake port 404, the check valve will move to the closed position sealing off the exhaust port 402 from the intake port 404. For example, if the pressure on the transfill hose side of the exhaust port 402 reaches about ten percent of the pressure at the intake port 404, the combination of the biasing force of the spring 604 and the pressure at the exhaust port 402 may be sufficient to move the check valve 602 to the closed position.

This may not only complete a refilling process of the air tank but also prevents the backflow of breathable air from the air tank into the conduit flow section 104 of the coupling body 101. Similarly, if the SCBA is disconnected from the air coupling 302, the check valve 602 returns to the closed position under the normal biasing force of the spring 604.

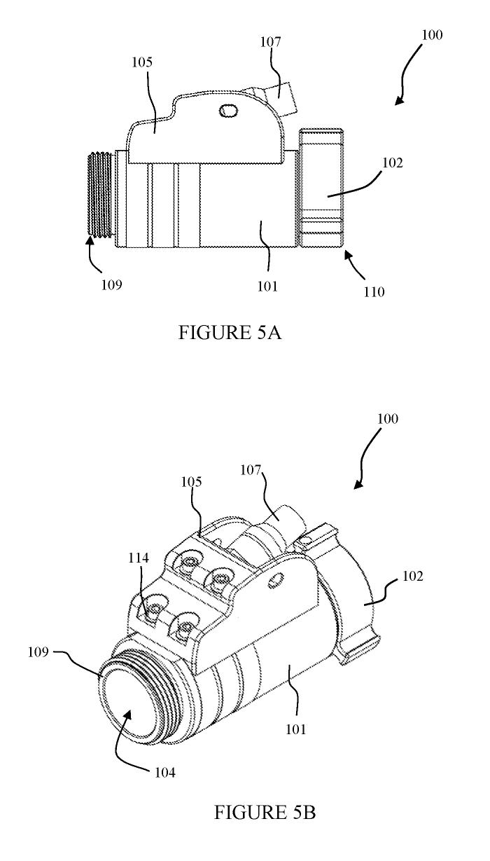

The valve housing 105 may be positioned in any suitable manner on the outer surface 108 of the coupling body 101. For example, as shown in FIGS. 1-4, the valve housing 105 may be positioned such that the air coupling 302 is positioned on the fire hose nozzle 111 side of the coupling body 101. Alternatively, as shown in FIGS. 5-8, the valve housing 105 may be positioned such that the air coupling 302 is positioned on the fire hose 112 side of the coupling body 101.

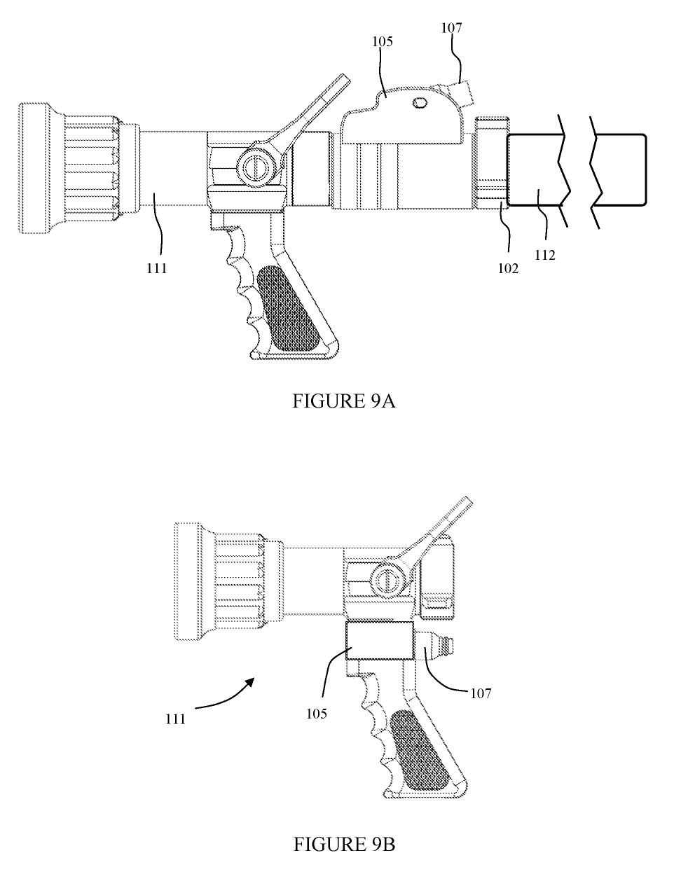

Referring now to FIG. 9A, in an alternative embodiment, the emergency air breathing system 100 may be integrated directly into the fire hose nozzle 111 as a single unit that may be connected to the fire hose 112. This configuration eliminates the need to couple the emergency air breathing system 100 between the fire hose 112 and the fire hose nozzle 111. In yet another embodiment and referring now to FIG. 9B, the emergency air breathing system 100 may be integrated into the handle of the fire hose nozzle 111.

Referring now to FIGS. 3, 4, 6, 8, and 10, the air coupling 302 may be coupled adjacent to the exhaust port 402 of the valve body 400. The air coupling 302 may comprise any suitable system or device configured to facilitate the flow of the breathable air from the valve body 400 to the SCBA. For example, when the valve body 400 is positioned in the open state, the breathable air may flow from the interior volume of the valve body 400 out of the exhaust port 402 into the air coupling 302. A separate transfill hose 1002 may attach to the air coupling 302 on a first end and attach to the SCBA at a second end. The breathable air may then be supplied to the SCBA thereby providing the firefighter with a constant supply of breathable air and/or be used to replenish a depleted store of breathable air in the air tank of the SCBA.

For example, if the emergency air breathing system 100 is configured to operate at pressures exceeding 300 psi, the air coupling 302 may comprise a Rapid Intervention Universal Air Connection (RIC UAC) fitting. The MC UAC fitting may be connected to the transfill hose 1002 and used to refill one or more air tanks of the SCBA. Alternatively, if the emergency air breathing system 100 is configured to operate at pressures between 70 psi and 160 psi, the air coupling 302 may comprise an Emergency Breathing Safety System (EBSS) fitting. The EBSS fitting may be connected to another EBSS fitting on the SCBA that leads to a regulator of the SCBA to allow for direct breathing.

The air coupling may comprise a cap 107 configured to be positioned over an exposed end of the air coupling 302. The cap 107 may comprise any suitable system or device configured to protect the air coupling 302 from environmental conditions and/or damage during use or storage. For example, when the emergency air breathing system 100 is not being used, the cap 107 may be placed over the air coupling 302 to keep foreign object debris such as dirt, dust, water, pests, and/or the like out of the air coupling 302.

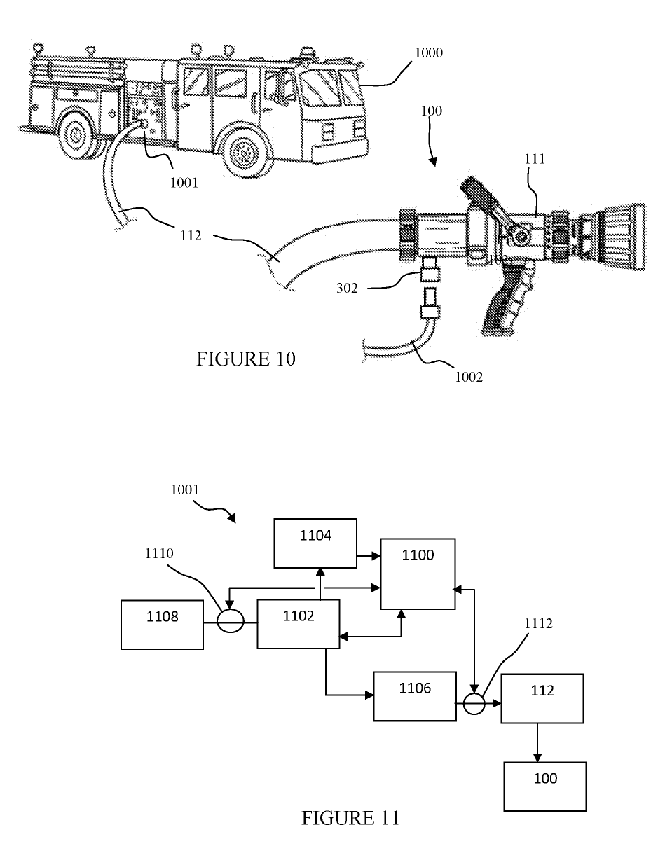

Now referring to FIGS. 10 and 11, in one embodiment, the emergency air breathing system 100 may further comprise an air injection system 1001 coupled to a pump panel 1100 on the firetruck 1000. The air injection system 1001 may comprise any suitable system or device configured to control a flow from a source 1108 of air (i.e., fire engine controller, spare SCBA tank(s), air generating truck, etc.) to the fire hose 112. For example, in one embodiment, the air injection system 1001 may comprise a control panel 1100, an air regulator system 1102, a pressure monitor 1104, a filter system 1106, and one or more check valves 1110, 1112.

The air regulator system 1102 receives the air from the air source 1108 through a first check valve 1110 and adjusts the pressure of the air to a desired level. The air regulator system 1102 may comprise any suitable system or device for controlling a delivery pressure of the air to the fire hose 112. For example, in one embodiment, the air regulator system 1102 may comprise a series of step regulators arranged to step the pressure from the source 1108 down incrementally to a desired level to account for pressure fluctuations that may be created as the source 1108 pressure is reduced.

The pressure monitor 1104 may be coupled to the pressure regulator system 1102 and be suitably configured to provide an indication of the pressure(s) being controlled by the individual step regulators to the control panel 1100. The pressurized air may flow from the pressure regulator system 1102 to the filter system 1106 where the pressurized air is cleaned or otherwise filtered to a level that creates pressurized breathable air. The operator may use the control panel 1100 to selectively operate the second check valve 1112 to allow the breathable air to flow into the fire hose 112. The control panel 1100 may also allow the operator to control the pressure regulator system 1102 to selectively adjust the pressure of the air being supplied to the fire hose 112.

The control panel 1100 may also comprise one or more adapters or connectors for connecting the air source 1108 to the pressure regulator system 1102. For example, the control panel 1100 may comprise an auxiliary air input configured to connect to the continuous source of air such as from an air compressor or cascade system. The control panel 1100 may also comprise an adapter configured to connect to a spare SCAB tank/bottle.

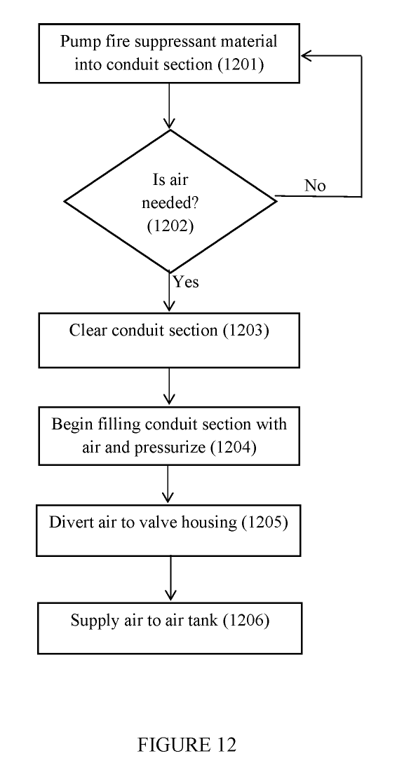

Now referring to FIG. 12, in operation, the emergency air breathing system 100 may be configured to deliver breathable air supplied from a fire truck 1000 to the SCBA worn by a firefighter via the fire hose 112 used by the firefighter upon the occurrence of an emergency event/condition. The event/condition may comprise any situation in which breathable air delivered via the fire hose 112 needs to be diverted into the valve housing 105, such as when a firefighter's SCBA air tank has run out of air and the firefighter is in need of additional breathable air.

In normal operation, the conduit flow section 104 of the coupling body 101 allows the flow of water, foam, and/or other fire suppressant/extinguishant supplied to the fire hose 112 to flow towards the fire hose nozzle 111. Upon demand, the emergency air breathing system 100 may be activated to redirect a flow of breathable air from the conduit flow section 104 to an air coupling 302 connected to the valve housing 105. For example, pressurized breathable air flowing in the conduit section 104 may be diverted into the valve housing 105 via the channel 406 formed between the exit port 208 of the coupling body 101 and the valve body 400.

For example, during the course of fighting a fire, a fire suppressant material is pumped through the fire hose 112, the conduit section 104 of the emergency air breathing system 100, and out of the fire hose nozzle 111 (1201). If a firefighter's air supply is exhausted, cut-off, and/or otherwise unavailable, the firefighter may alert an engineer at the location of the firetruck 1000 that additional breathable air is required (1202). The engineer may then shut off the supply of the fire suppressant material flowing through the fire hose 112, flush the line with air (1203). After the fire hose 112 has been flushed, the fire hose nozzle 111 may be closed allowing the fire hose 112 to pressurize with a supply of breathable air (1204).

Once the fire hose 112 and the conduit flow section 104 are pressurized with breathable air to a predetermined level, the emergency air breathing system 100 may be activated to divert at least a portion of the breathable air from the conduit flow section 104 through the valve housing 105 (1205). From there, the breathable air may flow through the valve body 400 and out of the exhaust port 402 into the air coupling 302 and subsequently to the SCBA carried by the firefighter (1206). At any given time, the emergency air breathing system 100 may be deactivated such that the flow of breathable air is prevented from being delivered into the valve body 400. The engineer at the firetruck 1000 may then be instructed to once again fill the fire hose 112 with the fire suppressant material instead of breathable air so that the firefighter can continue to fight the fire with a fresh supply of breathable air.

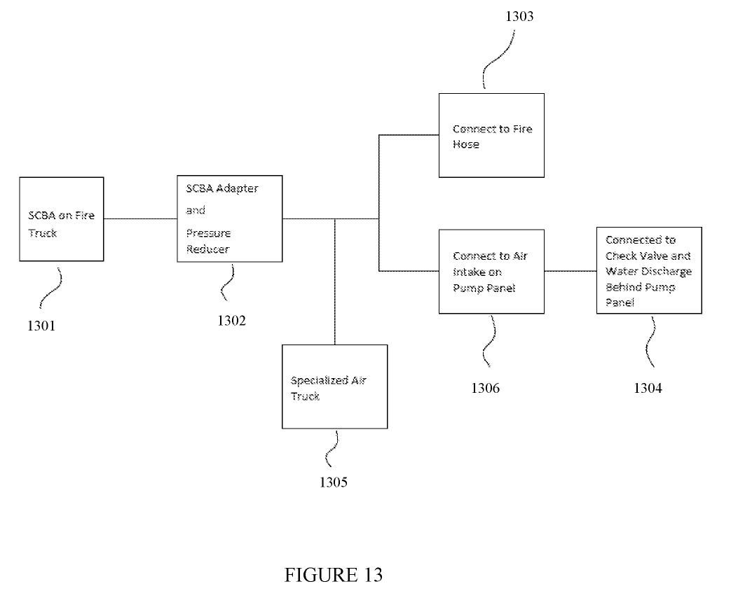

Now referring to FIG. 13, the emergency air breathing system 100 may be configured to obtain a supply of air from multiple sources. For example, the emergency air breathing system 100 may obtain air from a self-contained breathing apparatus (SCBA) disposed on the fire truck 1000 (1301). Air sourced from the SCBA disposed on the fire truck 1000 may be passed through an SCBA adapter and pressure reducer/regulator (1302) to pressurize the fire hose 112 to a desired level. The emergency air breathing system 100 may also obtain air from a specialized air truck (1305). In some configurations, air may be simultaneously sourced from either the SCBA on the fire truck 1000 and/or the specialized air truck. Air received by the emergency air breathing system 100 may be configured to be delivered to one of two injection points. The first injection point may be configured to be directly coupled to the fire hose 112 (1303). The second injection point may be configured to be connected to control panel 1004 of the fire truck 1000 (1306). The control panel 1004 may also comprise a check valve and water discharge (504).

In one embodiment, the air tanks from multiple SCBA's may be refilled from a single emergency air breathing system 100. The emergency air breathing system 100 may be configured with any suitable system or device configured to allow multiple air tanks to access the breathable air supplied via a fire hose 112. For example, a first firefighter may connect a transfill hose 1002 of their SCBA to the air coupling 302 to access the breathable air. A second firefighter may connect a transfill hose 1002 of their SCBA to the air tank of the first firefighter's SCBA such that both the first firefighter and second firefighter has access to the breathable air supplied by the fire hose 112. Additional firefighters may receive breathable air by connecting their transfill hoses in a similar manner to the SCBA of those firefighters who are connected to the emergency air tank refilling system 100. Alternatively, the valve housing 105 may be configured with additional air couplings 202, whereby multiple firefighters may connect the transfill hose 1002 of their SCBA to the additional air couplings 202 such that the emergency air breathing system 100 may be configured to refill multiple air tanks simultaneously.

The particular implementations shown and described are illustrative of the technology and its best mode and are not intended to otherwise limit the scope of the present technology in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing specification, the technology has been described with reference to specific exemplary embodiments. Various modifications and changes may be made, however, without departing from the scope of the present technology as set forth in the claims. The specification and figures are illustrative, rather than restrictive, and modifications are intended to be included within the scope of the presented technology. Accordingly, the scope of the technology should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. An emergency breathing device for routing air from a fire hose coupled to a fire hose nozzle to a self-contained breathing apparatus (SCBA) having a transfill hose carried by a firefighter, comprising:
a coupling body, comprising:
a first end configured to be detachably coupled to the fire hose nozzle;
a second end configured to be detachably coupled to the fire hose;
a conduit flow section disposed within the coupling body and extending between the first and second ends, wherein the conduit flow section comprises an internal diameter of between one and one-half inches and three inches; and
an exit port disposed along the conduit flow section, wherein:
the exit port provides a fluid path from the conduit flow section to an exterior surface of the coupling body; and
the exit port comprises a diameter between one-thirtysecondths of an inch and one-eighth of an inch; and
a valve housing coupled to the outer surface of the coupling body, wherein the valve housing comprises:
an intake port aligned with the exit port, wherein the intake port comprises a diameter between one-thirtysecondths of an inch and one-eighth of an inch;
an exhaust port disposed downstream of the intake port;
an air coupling coupled to an outlet of the exhaust port, wherein the air coupling is configured to be selectively attached to the transfill hose; and
a check valve positioned between the intake port and the exhaust port, wherein the check valve:
is biased to a closed position sealing the exhaust port off from the intake port;
is responsive to a detected pressure at the exhaust port that is lower than a pressure at the intake port after the transfill hose is connected to the air coupling;
opens in response to the detected lower pressure at the exhaust port; and
closes when the pressure at the exhaust port is within approximately ten percent of the pressure at the intake port.

2. The emergency breathing device of claim 1, wherein the check valve is configured to close in response to the transfill hose being disconnected from the air coupling.

3. The emergency breathing device of claim 1, wherein:
the first end comprises a threaded male connector; and
the second end comprises a female coupler.

4. The emergency breathing device of claim 1, wherein coupling comprises a high pressure quick disconnect coupling having an operating pressure greater than 300 psi.

5. The emergency breathing device of claim 1, wherein coupling comprises a quick disconnect coupling having an operating pressure of between 70 psi and 160 psi.

6. An emergency breathing device for routing air from a fire hose coupled to a fire hose nozzle to a self-contained breathing apparatus (SCBA) carried by a firefighter, comprising:
a coupling body having a conduit flow section extending between opposing first and second ends, wherein:
the coupling body is configured to be positioned between the fire hose and the fire hose nozzle;
the conduit flow section comprises an internal diameter of between one and one-half inches and three inches; and
an exit port extending between the conduit flow section and an outer surface of the coupling body, wherein the exit port comprises a diameter between one-thirtysecondths of an inch and one-eighth of an inch; and
a valve housing coupled to the outer surface of the conduit body, wherein the valve housing comprises:
an intake port fluidly linked with the exit port; and
an exhaust port disposed downstream of the intake port; and
a check valve positioned between the intake port and the exhaust port, wherein the check valve:
is biased to a closed position sealing the exhaust port off from the intake port;
is responsive to a detected first pressure at the exhaust port that is lower than a second pressure at the intake port;
opens in response to the detected lower first pressure at the exhaust port; and
closes when the first pressure is within approximately ten percent of the second pressure.

7. The emergency breathing device of claim 6, wherein:
the first end of the coupling body is configured to be detachably coupled to the fire hose nozzle; and
the second end of the coupling body is configured to be detachably coupled to the fire hose.

8. The emergency breathing device of claim 7, wherein:
the first end comprises a threaded male connector; and
the second end comprises a threaded female coupler.

9. The emergency breathing device of claim 6, wherein the valve housing further comprises an air coupling coupled to an outlet of the exhaust port.

10. The emergency breathing device of claim 9, wherein coupling comprises a high pressure quick disconnect coupling having an operating pressure greater than 300 psi.

11. The emergency breathing device of claim 9, wherein coupling comprises a quick disconnect coupling having an operating pressure of between 70 psi and 160 psi.

12. The emergency breathing device of claim 6, wherein the valve housing further comprises a spring providing a biasing force on the check valve.

13. An emergency breathing system for routing air from a fire hose, having a first end coupled to a fire hose nozzle and a second end coupled to a fire truck, to a self-contained breathing apparatus (SCBA) carried by a firefighter, the emergency breathing system comprising:
a coupling body having a conduit flow section extending between opposing first and second ends, wherein:
the coupling body is configured to be positioned between the fire hose and the fire hose nozzle;
the conduit flow section comprises an internal diameter of between one and one-half inches and three inches; and
an exit port extending between the conduit flow section and an outer surface of the coupling body, wherein the exit port comprises a diameter between one-thirtysecondths of an inch and one-eighth of an inch;
a valve housing coupled to the outer surface of the conduit body, wherein the valve housing comprises:
an intake port fluidly linked with the exit port; and
an exhaust port disposed downstream of the intake port; and
a check valve positioned between the intake port and the exhaust port, wherein the check valve:
is biased to a closed position sealing the exhaust port off from the intake port;
is responsive to a detected first pressure at the exhaust port that is lower than a second pressure at the intake port;
opens in response to the detected lower first pressure at the exhaust port; and
closes when the first pressure is within approximately ten percent of the second pressure at the intake port; and
an air injection system positioned at the fire truck and linked to the second end of the fire hose, wherein the air injection system is configured to control a flow of breathable air to the fire hose.

14. The emergency breathing system of claim 13, wherein the air injection system comprises:
a source of air;
a pressure regulator system pneumatically linked to the source of air, wherein the pressure regulator is configured to adjust a pressure of the air to a desired level;
a filter system positioned between the pressurized air and the second end of the fire hose; and
a control panel configured to allow an operator to selectively control the pressure regulator system and the flow of breathable air.

15. The emergency breathing system of claim 14, wherein the pressure regulator system comprises at least two pressure regulators configured to arranged to step a pressure from the source of air down incrementally to a desired level.

16. The emergency breathing system of claim 14, wherein the air injection system further comprises:
a first check valve positioned between the source of air and the pressure regulator; and
a second check valve disposed between the filter system and the fire hose.

17. The emergency breathing system of claim 16, wherein the control panel selectively controls the first and second check valves to control a flow of air through each valve.
